(19) United States
(12) Patent Application Publication
(10) Pub. No.: US 2013/0262228 A1
(43) Pub. Date: Oct. 3, 2013

(54) Digital Marketing Platform With Formatted Advertising Feature Coupled To Normalized Inventory Management System and Supply Chain Management System Feeds

(71) Applicant: Zencolor Corporation, Coral Gables, FL (US)

(72) Inventors: Dann Gershon, Coral Gables, FL (US); David Robinson, Jersey City, NJ (US); Jonathan Wilder, Miami, FL (US)

(73) Assignee: Zencolor Corporation, Coral Gables, FL (US)

(21) Appl. No.: 13/857,685

(22) Filed: Apr. 5, 2013

Related U.S. Application Data
(63) Continuation-in-part of application No. 13/762,160, filed on Feb. 7, 2013.
Application No. 13/762,160 is a continuation-in-part of application No. 13/762,281, filed on Feb. 7, 2013.
(60) Provisional application No. 61/656,206, filed on Jun. 6, 2012.
(60) Provisional application No. 61/679,973, filed on Aug. 6, 2012.
(60) Provisional application No. 61/792,401, filed on Mar. 15, 2013.
(60) Provisional application No. 61/595,887, filed on Feb. 7, 2012.
(60) Provisional application No. 61/595,887, filed on Feb. 7, 2012.

(30) Foreign Application Priority Data
Feb. 7, 2013 (US) PCT/US2013/025135
Feb. 7, 2013 (US) PCT/US2013/025200

(51) Int. Cl. G06Q 30/02

(52) U.S. Cl. CPC G06Q 30/0255
USPC 705/14.53

(57) ABSTRACT

A marketing platform enhancement to generate and transmit formatted advertisements and digital catalogs by utilizing user demographics and preferences to generate targeted and micro-targeted marketing materials. The customized advertisements and digital catalogs that are created draw upon up-to-date information maintained by merchant supply chain management systems (SCM) and/or inventory management systems (IMS) to more effectively and more frequently advertise merchant products based on user preferences.

### RELATED APPLICATIONS

This application is a Continuation-In-Part application of application Ser. No. 13/762,160 and corresponding international application PCT/U.S.13/25135, both filed on Feb. 7, 2013 and entitled Color-Based Identification, Searching and Matching Enhancement of Supply Chain and Inventory Management Systems, and application Ser. No. 13/762,281 and corresponding international application PCT/U.S.13/25200, both filed on Feb. 7, 2013 and entitled Mobile Shopping Tools Utilizing Color-Based Identification, Searching and Matching Enhancement of Supply Chain and Inventory Management Systems, all of which claim the priority of U.S. Provisional Patent Application No. 61/595,887 filed on Feb. 7, 2012, U.S. Provisional Patent Application No. 61/656,206 filed on Jun. 6, 2012, and U.S. Provisional Patent Application No. 61/679,973 filed on Aug. 6, 2012. The present invention further claims priority to U.S. Provisional Patent Application No. 61/792,401 filed on Mar. 15, 2013. All of the foregoing applications are incorporated herein by reference.

### FIELD OF THE INVENTION

The present invention relates to digital marketing and promotional tools for merchants. More particularly, the invention relates to the creation and dissemination of targeted and micro-targeted, formatted advertising by merchants to users based in part upon information originating from a single or plurality of proprietary supply chain management systems and/or inventory management systems.

### BACKGROUND OF THE INVENTION

At times, a user will want to search for a product by color even though it is an abstract attribute that cannot be described adequately using words. For example, other than using rudimentary color names, such as “red” and “blue,” searching for products of a particular shade using color as a parameter is extremely difficult, even when the color is relatively popular and intuitively should be easy to locate. For example, there are numerous colors which would fit the simple “red” or “blue” description, and searching using the textual word “red” is not likely to bring up the specific red or the specific product of interest. Also, searches based on a particular type of color by name, such as “rose red” or “ocean blue” are unlikely to turn up the color of interest, as there may be a number of different colors, each with a different name or with multiple names varying by the naming convention used. Similarly, searching for a pattern made of colors, such as “blue and red stripes” is unlikely to turn up the desired pattern of particular colors.

Further highlighting the problem is that searching for a fanciful color name (i.e., a name which does not have any associated color as part of the name), such as “sunrise swirl,” is likely to return a host of irrelevant results, thus negating the benefits of internet searching altogether. While some extremely small percentage of results conceivably may be pertinent, identifying a relevant reference from among the plethora of others is extremely difficult and time-consuming, thus rendering the process of color-searching under these circumstances an exercise in futility.

Many of the drawbacks involving color-based searching stem from the nature of internet searching, which has historically been text-based, thus requiring a user to enter text into a search engine to describe the information sought. With regard to color, textual color names are typically tagged or embedded beneath an image of a product or associated webpage as metadata, making it virtually impossible to obtain reliable and complete search results when specific color shades are sought. More specifically, because many search systems that implement searching based on a color (or a pattern) are operable only as text searching, a system may allow a user to select a color by name or even “click” on the color (in the form of a color swatch) and then search for the selected color. However, in these instances, the system typically converts the inputted search parameter to a text-string associated with or representing a particular color. For example, a search system may search based on clicking red swatch on a webpage but converts the click to a search for “red” as text, but not as an actual color. In such a system, the name of the color “red” is “tagged” to an image by way of a text string and the search is based by matching the input “red” to the text string “red” on the tag, and not to the color. From a consumer's perspective, such a system is insufficient to reliably capture all relevant products of a particular shade of red that are being sought. From a merchant perspective, such a system does not allow for dynamic analysis or codification of color which is a crucial but missing data set in understanding consumer preferences.

Another issue with conventional color and product searching is that to the extent any useful information is available, it must first be ‘scraped’ by a search engine and indexed for searching. This creates a significant burden on merchants which must first act as content providers, uploading information to be scraped so that the content is available for indexing and subsequent searches by users.

Another problem with contemporary color searching is a lack of universal color codification and unifying color naming conventions. For example, even when a search using a specific color such as “cherry red” yields some relevant results when utilizing a search engine or a search field on a particular merchant's website (i.e., where the merchant utilizes the term “cherry red” as a tag to identify some of its products), such searches do not yield all of the relevant results for the particular type of red being searched. This is the case even when there are available products sold by other merchants that have the identical color or a close equivalent color but which use a term other than “cherry red” to identify that color.

Even color systems that offer naming conventions suffer from underlying drawbacks in their inconsistent application by merchant users and their vendors. For example, a wholesale buyer for a retailer may decide to order a line of products from a vendor in a color that is identified as “cobalt blue.” A second wholesale buyer at the same retailer may order another line of products from a second vendor in a color that the second buyer also identifies “cobalt blue,” having the intention that the colors be precisely the same so that a purchaser of product from the first line will be more inclined to purchase the second line of product as a matching set. Indeed, the variation in color between two products that purportedly have the ‘same color’ can be remarkable when the products are placed side by side. The lack of consistency among vendors and suppliers, even when the same color names are utilized, is often not appreciated until after the products arrive, at which time it is too late to ameliorate the situation.

FIG. 1 is a flow diagram which illustrates some of the chief drawbacks of prior art contextual color data implementations. Essentially, when conducting text-based color searches across disparate data sources, the resulting data cannot be compared or codified into a single system. This results in entirely useless or inaccurate color search data and color analytic data since there is no means by which to categorize and codify the color data under a single umbrella. By the same token, applications and software which subsequently integrate these color-based results and analytics are ineffective and/or unreliable.

The drawbacks presented above with respect to color are compounded in the context of creating effective marketing and promotional content and materials. As merchant marketing budgets are under increasing pressure to have their advertising dollars result in actual sales, there is an increasing need by these merchants to create effective advertisements that have a greater chance of success. One problem which prevents this need from being satisfied is that current forms of digital advertising are not equipped to target and micro-target a single user or multiple users with products having colors and other significant attributes which may cause those products to be more likely or prone to purchase by a particular user. Rather, many forms of advertisements, such as “purchase suggestions,” are based on simplistic models which merely review past purchases by consumers and relate the products from those purchases to one another to create a purchase suggestion to others. This form of advertising does not take actual user preferences, such as color, into consideration and in many instances could result in user dissatisfaction with the merchant sourcing the advertisement.

Another problem which inhibits the creation of advertisements that have a greater chance of serving their intended purpose is the current inability to create formatted forms of targeted and micro-targeted advertisements based on user-specific data that draw upon the content provided directly from merchants' existing inventory management systems and supply chain management systems feeds. The inability to create and customize advertisements based on real-time merchant data results in advertisements that miss the mark, that have information that is inconsistent with actual merchant data, that are cluttered or which suffer from other flaws.

### BRIEF DESCRIPTION OF THE PRESENT INVENTION

It is a primary objective of the present invention to provide an improved marketing platform to create and disseminate more effective targeted and micro-targeted advertisements to users.

It is a further object of the present invention to create an improved marketing platform to create formatted advertisements based on available user preferences or known user demographics which also draw upon information from and are served by merchant proprietary supply chain management systems and/or inventory management systems.

It is another objective of the present invention to provide a universal convention for color-based advertising by merchants to consumers to create color-specific advertisements based on available user preferences or known user demographics which also draw upon information from and are served by merchant proprietary supply chain management systems and/or inventory management systems.

It is a further objective of the present invention to eliminate the need for merchants to undertake the expensive and burdensome task of uploading product data to enable scraping of merchant websites to reach target consumers via online search engine searches.

Further objectives of the invention will be apparent from the disclosure which follows. Generally, the present invention is directed to a marketing platform enhancement to create formatted advertisements built around user demographics to generate targeted advertisements and/or more specific user preferences to generate micro-targeted advertisements when more detailed data about a user is available. The formatted advertisements that are generated draw upon current information maintained by merchant supply chain management systems (SCM) and/or inventory management systems (IMS) to more effectively advertise merchant products. In addition, the marketing platform helps reduce, if not eliminate, merchant reliance upon the manual upload of product data as a means to reach consumers with their products.

In a preferred embodiment, the marketing platform enhancement of the present invention is integrated into and functions together with the system hardware and software components disclosed herein and in greater detail in U.S. application Ser. Nos. 13/762,160 and 13/762,281, and corresponding international applications PCT/U.S.13/25135 and PCT/U.S.13/25200, respectively. The system, methods and interfaces disclosed in these applications enable the dynamic analysis and codification of color as illustrated in FIG. 2, generally enabling color data to be categorized and codified from among disparate sources into a single system. Since color-based data can be effectively collected and organized, non-contextual color-based searches, results and color analytics are meaningful. Ultimately, products utilizing and implementing these by-products of color codification provide both useful and accurate data across the spectrum of color that was previously unavailable.

As an upgrade to SCM and/or IMS systems, the marketing platform enhancement utilizes user history (e.g., purchases, shares, bookmarks etc.) to facilitate the generation, formulation and distribution of marketing and advertising materials (whether digital or non-digital), product planning and sales.

The system includes one or more servers operated by machine-readable software instructions present on non-transitory computer readable storage media to perform a variety of functions associated with product identification, searching and matching utilizing color as a principle attribute, without the need to input a text-based term in place of a color. These are complemented by features and controls that enable the generation and distribution of formatted targeted and micro-targeted advertisements to users to drive merchant sales, and simultaneously decrease merchant reliance upon mundane, text-based searches as a means to create traffic and sales revenue. While some additional hardware and/or software constructs are required to implement the advertising features of the present invention, those of ordinary skill in the computer and software arts will appreciate how to implement these features based on the disclosure herein.

The system of the present invention is designed and intended to perform the following tasks:

1. Process and integrate data from merchant IMS and SCM system(s) via formatted data feeds to create a database of products with corresponding color information (i.e., digitally defined color identifier);

2. Gather available supplementary data from merchant IMS and SCM system(s) via formatted data feeds which are used to enhance the user shopping experience and the merchant commercial experience from the initiation of production through final sale;

3. Provide interfaces for users to query product databases with real-time merchant IMS and SCM system(s) information, using digitally defined color identifiers, and to purchase products from multiple merchants based on color and other customizable parameters;

4. Dynamically analyze codified color-based preferences, trends and system-wide activities to make targeted and micro-targeted product recommendations to users with color as a primary product attribute;

5. Generate formatted advertisements that are based upon user-specific data (i.e., demographics and/or user preferences/history) and current, up-to-date IMS and SCM system(s) information which are tailored for and distributed to specific consumers. In a preferred embodiment, the targeted and micro-targeted advertisements further utilize a universal, color-based identifier to market products of specific color(s) to an intended user or audience.

With respect to the hardware of the system, CPU-based servers are arranged to communicate with one another and with one or more data warehouses, preferably residing therein, which are used to store user data, merchant data, product data, and color data. In a preferred embodiment, servers receive formatted data feeds from IMS and SCM systems which populate the data warehouse once the data is normalized by machine processes. The servers and software gather, parse and filter the data warehouse data according to encoded instructions to allow a user to search for and purchase products from merchants.

### BRIEF DESCRIPTION OF THE DRAWINGS

The above-described and other advantages and features of the present disclosure will be appreciated and understood by those skilled in the art from the following detailed description and drawings of which:

FIG. 1 is a flow diagram depicting general drawbacks of prior art contextual color data implementations;

FIG. 2 is a flow diagram depicting the benefits of non-contextual color data implementations of the present invention;

FIG. 3 illustrates a basic system configuration fashioned in accordance with the present invention;

FIG. 4 is a flow diagram depicting the consumption and integration of proprietary merchant IMS and SCM systems data carried out by machine processes that perform the functions of data normalization, dynamic analysis, conversion and storage, and data syncing;

FIGS. 5A and 5B together comprise a system diagram depicting interaction among various system segments and functions carried out in accordance with the present invention, including data consumption, data search, data analytics and digital marketing;

FIG. 6 illustrates the dynamic color analysis engine of the present invention and its sub-modules;

FIG. 7 illustrates an embodiment of a graphical user interface or display for color search access

FIG. 8 is a flow diagram depicting the flow of data originating from proprietary merchant IMS and SCM systems to generate and implement formatted, targeted and micro-targeted advertising content;

FIG. 9 is a preferred embodiment of a formatted advertisement populated with information obtained from proprietary merchant IMS and SCM systems;

FIG. 10 is a preferred embodiment of a digital catalog layout interface in accordance with the present invention;

FIG. 11 is a flow diagram depicting the functionality of an interactive embedded advertising application.

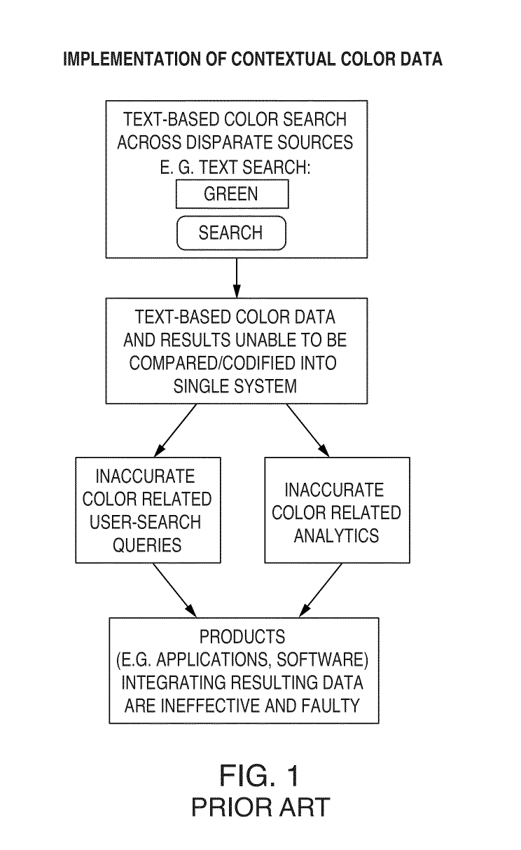

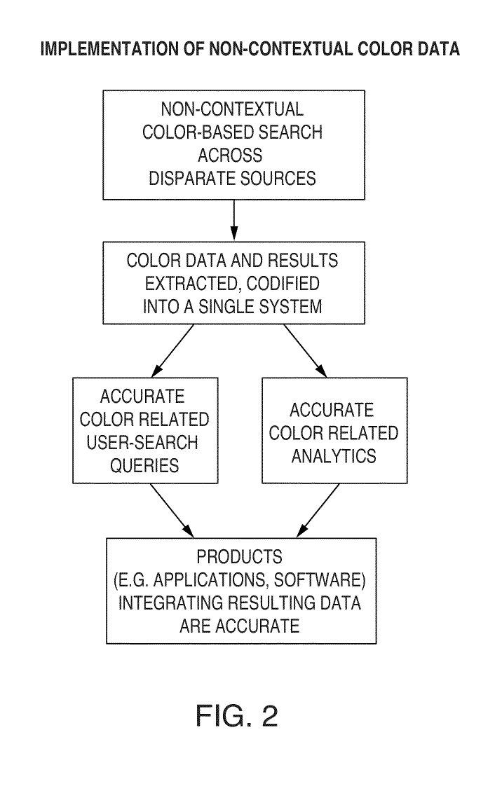

### DETAILED DESCRIPTION OF THE INVENTION

The present invention is a marketing platform enhancement to create and transmit targeted advertising, the content of which is clearer, more organized, focused, relevant and current than existing forms of digital and traditional advertising. Advertisements are generated by or on behalf of merchants and distributed to users based upon their historical activities and/or demographics, utilizing or in combination with current information maintained by merchant SCM and/or IMS system(s). Generated advertisements are distributed to users via known email addresses gathered from users or from third parties on behalf of users, via subscription services, or via other available contact means (e.g., directly to handheld device or via data provider of handheld device). The advertising tools disclosed herein take advantage of and build upon the infrastructure implemented in connection with the core system, methods and interfaces that gather, identify, search for and match products based on color, without the need to resort to text-based or contextual searches. Accordingly, there is significant overlap between the features enabled in the core system and those which serve the formatted advertising platform.

As an enhancement of proprietary merchant IMS and SCM systems, the preferred embodiment of the present invention permits merchants to conduct real-time (or more frequently updated) data analytics that are based on universal color data, which is a data set that has heretofore been unavailable to merchants for the purpose of conducting analytics. These analytics are instrumental to enabling retailers and their manufacturers make or adjust supply chain and inventory decisions sooner and more effectively in accordance with shifting consumer demand and commercial activities.

Moreover, these analytics enable merchants to generate advertisements to users that are based upon targeted and micro-targeted data which is parsed and incorporated into an advertising layout that is populated using data fed from merchant IMS and SCM systems.

As referenced herein, the term “user” may properly refer to a merchant or to an individual shopper or consumer. However, it should be understood, unless otherwise indicated or apparent from the specification, that the term “user” typically refers to an individual shopper or consumer. In addition, it should be understood that a preferred embodiment of the present invention is implemented primarily, but not exclusively, as a web-based system with accessibility to the system and its databases via an open distributed computer system, such as the Internet. Moreover, while the discussion below is often with reference to a single server and storage device, it should be appreciated that a number of servers and storage devices may be utilized in tandem to implement the system.

In addition, unless otherwise noted or apparent from the context, reference to the term “merchant” should generally be interpreted broadly to include, for example, wholesalers, retailers, suppliers, manufacturers, vendors and commercial enterprises from designers down the chain of sale to consumers. However, it should be appreciated that in some instances, the term should be construed in a more limited manner applying to some forms of merchants but not others.

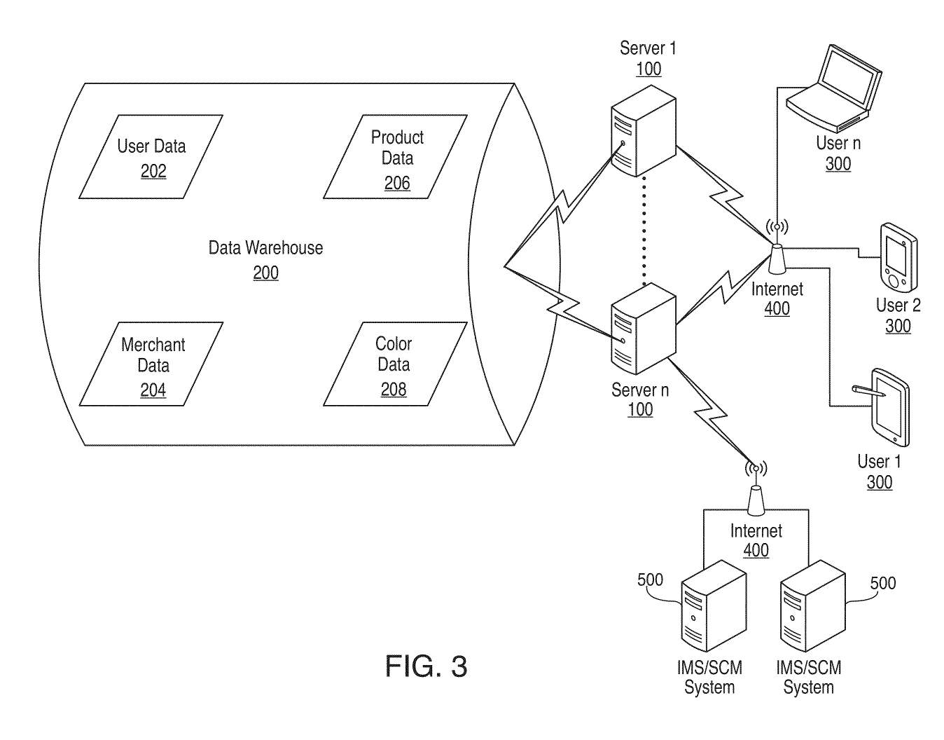

With reference to FIG. 3 there is shown a basic system configuration comprising a processor-based machine, such as computer(s) or server(s) 100, with hard disk or memory drives running software comprising machine readable program instructions. Server 100 serves as and/or provides access to data warehouse 200, which comprises data stores with information related to users 202, data stores with information related to merchants 204, data stores with information related to products 206, and data stores with information related to color 208. All data are maintained in data warehouse 200 or other conventional database system having read and write accessibility using a database management system. Although described herein for illustrative purposes as being separate data stores, in at least some alternative embodiments, the data stores may be combined in various combinations.

Information contained in data warehouse 200 is accessible by both consumer and merchant users operating devices 300 over the Internet 400. Devices 300 comprise processor-based machine(s), such as laptops, PCs, tablets and/or other handheld devices to and from which server 100 communicates. Devices 300 are connected to server 100 utilizing customizable interfaces described herein. Custom interfaces may be in the form of a graphical user interface, an application to form a client-server arrangement and/or other well-known interface conventions known in the art. Depending on the nature of the user and its access to various forms of information, different interfaces are made available. To support various options, the system of the present invention may include at least one application programming interface (API) so that certain types of users could enhance their interfaces, and different ones may be available for users and merchants.

Each data set introduced in the data warehouse 200 represents interrelated data sets that communicate with and rely on other data sets for complete information (but do not necessarily represent discrete data sets). These data sets may be accessed using a variety of database management systems (DBMS), including but not limited to relational database management systems (RDBMS) and “post-relational” database management systems (e.g., not only Structured Query Language (“NOSQL”) database management systems). In this manner, the data sets illustrated in FIG. 3, namely, user data 202, merchant data 204, product data 206 and color data 208, are meant to be purely illustrative and are not intended to necessarily depict a physical housing of data. Furthermore, by using a DBMS such as RDBMS or a “post-relational” DBMS, the data may be available to a merchant in a variety of manners, such as based on a specific demographic profile or a specific color or color grouping.

In a preferred embodiment of the present invention, user data 202 includes data specific to individual users which users may wish to make available, such as:

1. Personal information, including but not limited to, username, name, address (including email address, physical address and more generalized geographic information, such as North America, Northeastern United States, New York etc.), telephone data, contact data, birth date information, astrological information, keywords with which the user associates, colors with which the user associates specific keywords, etc.

2. Demographic information, including but not limited to, age, gender, education history, income, marital status, occupation and religion.

3. Color preference and bookmark data;

4. Product history information, including but not limited to, browsing history, product ratings (e.g., like and hide), purchase history, favorite stores, favorite brands; and

5. Social information including specifics for user-to-user or user-to-merchant associations including, but not limited to, friends, family, colleague, romance, and acquaintance associations.

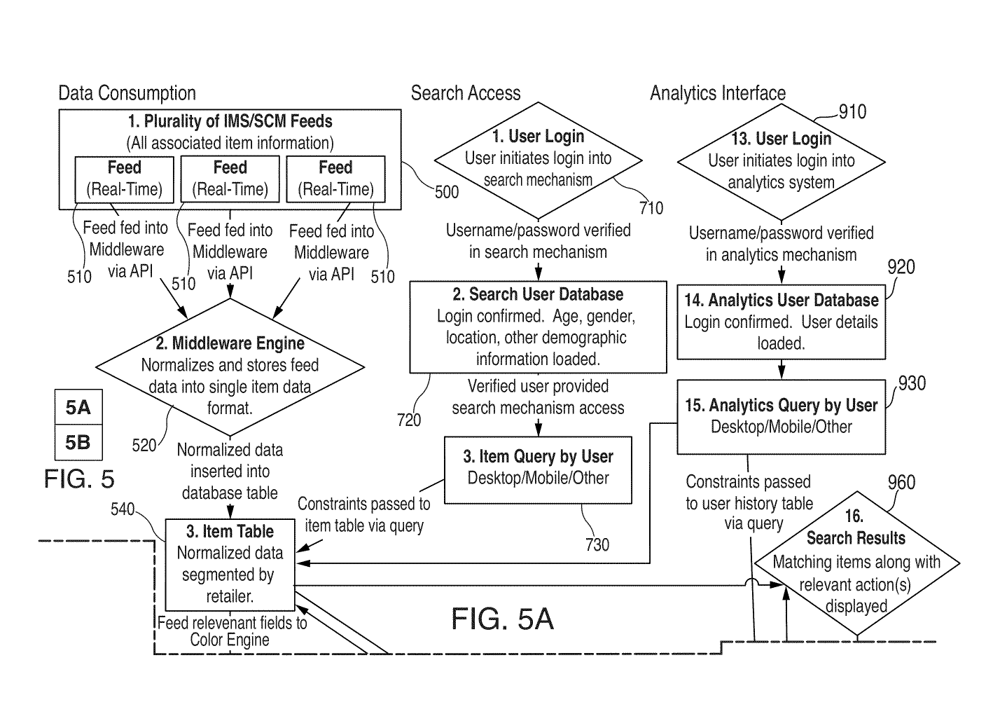

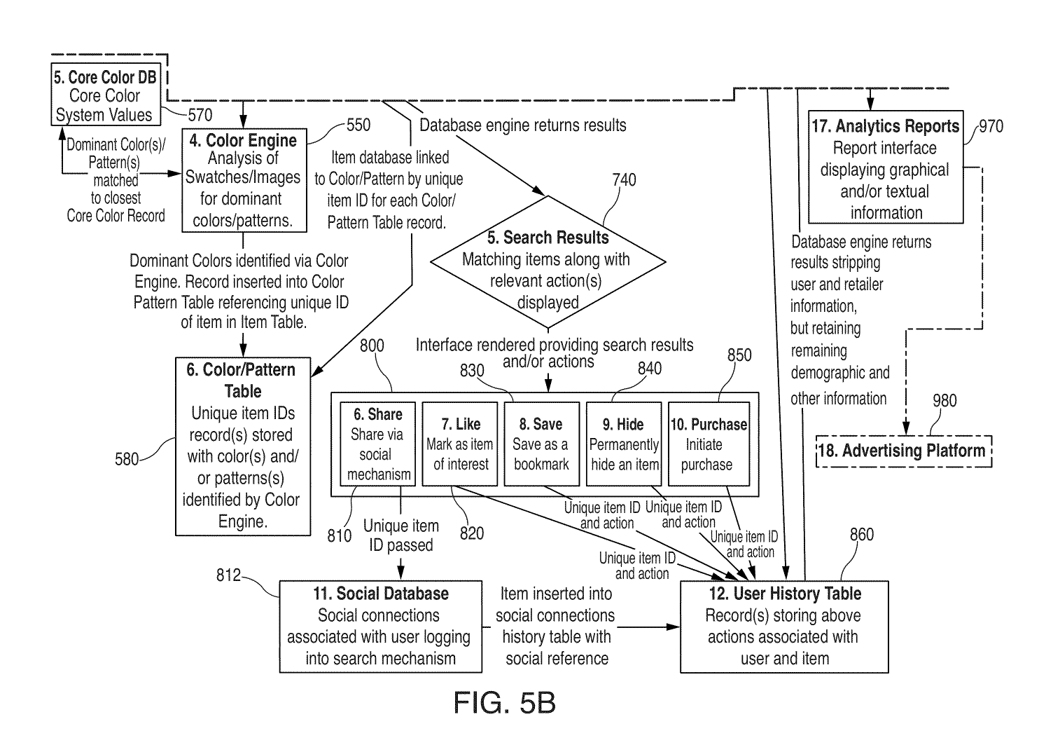

Personal information and demographic information are typically acquired from a user in the context of an initial user registration process and subsequently stored in a user history table 860 (see FIG. 5B) which contain a broad range of records pertaining to user identification and user selections.

The remaining forms of user data 202 are acquired and recorded in the user history table 860 as a result of user-system interactions via a graphical user interface. These interactions will be described below in further detail.

In a preferred embodiment of the present invention, merchant data 204 includes data specifics for a merchant, such as:

1. Business name, contact name, address, telephone number;

2. Demographic information, including but not limited to, target demographics, user and merchant demographics and preferences. As above in the context of user data 202, demographic information in the context of merchant data 204 include, without limitation, socio-demographic information such as age, gender, location, education level, income level, marital status, occupation, religion, ethnicity. For a merchant, these attributes are related back to users in order to aggregate and define common sets of customers, giving insight into the best means to target consumers for a particular merchant advertiser. Once certain purchasing trends by a particular group of users are observed or perceived, filters may be applied to target those or other users with advertisements based on specific demographic attributes;

3. Physical locations;

4. Inventory information;

5. Supply chain information;

6. Planogram and store schematic information; and

7. Purchase history information;

In a preferred embodiment of the present invention, product data 206 includes data specifics for products, such as:

1. Basic product identification information, including name of product;

2. Color identification information, including universal hexadecimal color code and corresponding component red, green, blue (RGB) values, color histogram and statistical information;

3. Pattern identification information, where applicable;

4. Image data, preferably in the form of a three-dimensional digital rendition of the product or another form of digital image of the product;

5. Recommendation data, including historical recommendations of products, ratings of products and advertisement data pertaining to products; and

6. Current and future product availability information.

It should be appreciated that data stored as product data 206 can be indexed and cross-referenced in a number of useful ways by associating the product data 206 with specific types of user data 202, merchant data 204 and color data 208. Thus, various types of product data 206 can be referenced and manipulated utilizing, for example, any combination of color, land location, user preference and demographic. In that way, data in the data warehouse 200 is interrelated forming a powerful tool in the context of predictive analytics.

In a preferred embodiment of the present invention, color data 208 includes data specifics for color information, such as:

1. Color identification information in the form of hexadecimal codes for each selectable color;

2. Color identification information in the form of RGB component intensities for each selectable color, with RGB intensities mapped to the corresponding hexadecimal codes;

3. Pattern identification information in the form of pre-determined pattern configurations;

4. Statistical color information, such as frequency of products that contain a particular color among selectable colors, and trending information, such as which colors are forecasted as popular colors for selected past, present and future seasons;

5. Astrological information, including colors and keywords to describe colors are associated with each astrological sign for the purpose of collecting psychological color data;

6. Keyword information, such as frequent user-associated keywords relating to a particular color, such as, for the purpose of collecting psychological color data. The associated keywords may be based on (a) an original color-word association index; (b) user-defined keywords whereby a user associates colors with specific keywords; (c) pre-determined keywords which the user links with colors that the user determines are associated with those pre-determined keywords. The keywords and their color associations are stored and updated as users continue to update and create associations; and

7. Color grouping information, such as colors associated with a timeless collection or a particular trending collection (e.g., Spring 2012 colors).

Color identification information and pattern identification information are preferably maintained as a core color database 560 with individual entries corresponding to each selectable color and selectable pattern against which, in specified instances, dominant colors and patterns may be determined and associated with products after being transmitted to server 100.

In a preferred embodiment, the system, methods and interfaces described herein are designed to operate in a 4096 color environment, but on a scale which allows the system to expand to over 16 million colors using the full range of 256 color intensities (measured from 0 to 255) for each of R (Red), G (Green) and B (Blue) which yields 256³ or 16,777,216 possible color variations, and hence potential color classifications. In a preferred embodiment, the 4096 selectable colors are equidistantly spaced along the full scale of available colors. However, it should be understood that the selectable colors may be moved along the scale or added or subtracted in order to provide more or less variation in a particular color region, depending on user and merchant trends or needs.

Typically, the RGB codes or component intensities for a particular color are expressed as a 24-bit, 6-digit hexadecimal code which uses a base sixteen number instead of conventional base ten numbers, two digits for each of the Red, Green and Blue values. Similarly, colors may be expressed as a concatenation of digital values for R, G and B components of a color and assigned to a product as a color identifier. To that end, if a particular color exhibits RGB values: 189 Red: 202 Green: 220 Blue, that number is converted to a hexadecimal value BDCADC which is also used. 189 corresponds to BD in hex notation, 202 corresponds to CA in hex notation and 220 corresponds to CD in hex notation.

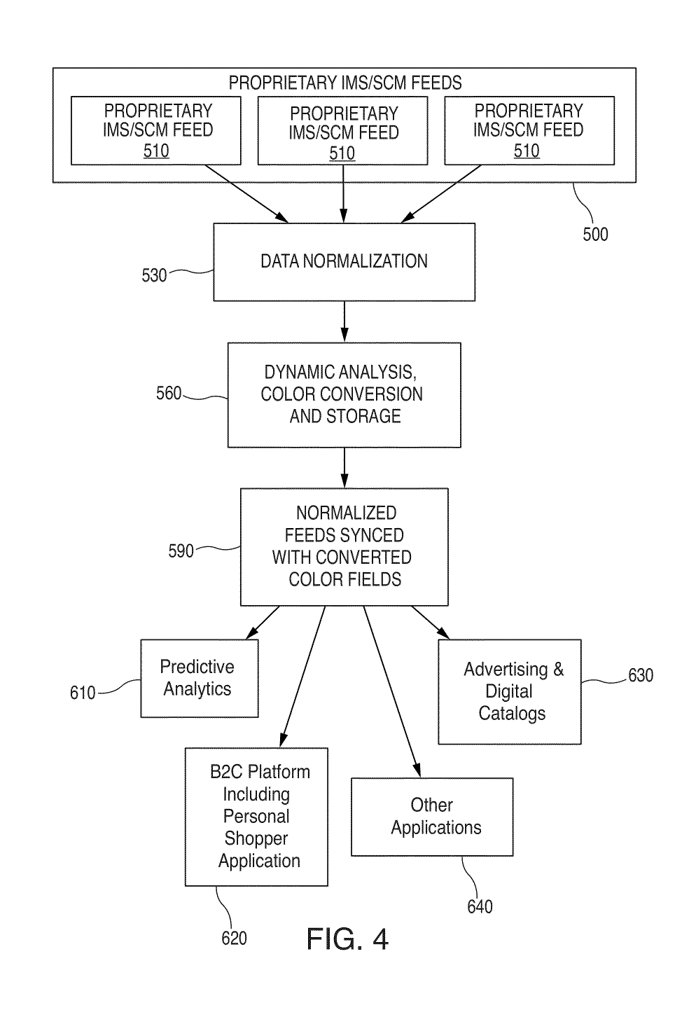

Referring again to FIG. 3, server 100 is also in communication with proprietary merchant IMS and SCM systems 500, which are typically closed systems that are inaccessible to the public or to third party merchants. As referenced in FIG. 4 and FIG. 5A, proprietary merchant IMS and SCM systems 500 provide continuous or frequently updated (in excess of once per day) data feeds 510 to server 100, which include product data, inventory data and supply chain data. This function is performed in a closed environment, typically tailored to the requirements and requests of individual merchants.

From a merchant perspective, basic merchant information (e.g., name of company, mailing address, contact information) is requested and integrated to create a merchant account and ID. As described in more detail below, once a merchant account is created, merchants provide formatted product feeds for processing that include basic product identification, pricing information and unique color information.

Under traditional circumstances, before data on a new product entering a merchant's product line is fed to server 100, that data is initially input into a merchant's SCM system in accordance with its pre-production and supply chain management practices. The input of that information conforms to a pre-approved, customized or stock format that is suitable to the merchant's routine practices and which coincides with a format that is compatible with server 100 software implemented for subsequent processing of the data.

For example, where a new product comprises a piece of clothing, available fields for supply chain data input may include any number of relevant categories, including product type, material type, size(s) and number of units to manufacture. These data, along with a hand- or computer-generated sketches and additional specification data containing further details about the product, may be utilized to create a digital three-dimensional (3D) model of the piece of clothing, which, in addition to the foregoing data, can optionally be stored as product data 206. Sketches may also be comprise 2D or 3D images, photographs, images or materials from which a 3D model may be generated. The number of fields may be expanded or contracted as desired so long as the format remains compatible with server 100 software so that the data in the field can be recognized and processed.

Significantly, fields that identify color utilizing an unmistakable, universal color identifier such as a hexadecimal color code (or its corresponding RGB component measurements or other digital representation) are required in most instances and comprise the most preferred means to identify color(s) in which a product is produced and input into a merchant SCM to initiate production. Alternatively, fields that accept an anonymous color swatch—from which a universal 24-bit hexadecimal color code (or its corresponding RGB component measurements) can be identified by a color engine 550 via image/swatch analysis 560—may be utilized as a less preferred but acceptable means to identify color. A field for proprietary color names owned and used by merchants may also be utilized in conjunction with the foregoing color identification information, but not as a replacement.

Upon following an acceptable format and input of information, SCM data feeds 510 are transmitted and loaded onto server 100 by the merchant's SCM system 500 as soon as the product goes into production. As products are manufactured and are ready to enter inventory, the databases in a merchant's IMS and SCM systems 500 are updated to reflect available inventory of product, resulting in additional data being sent from the closed IMS and SCM systems 500 to server 100. In a preferred embodiment, once products enter merchant inventory, events are triggered to issue and release targeted advertisements, digital catalogues and other marketing tools to connect now-available products with consumer users. Where there are delays in production of product of a certain color, the IMS and SCM feeds 510 are likewise updated, which may trigger other advertising events. As available products are sold, IMS and SCM systems 500 continue to be updated, with corresponding data being sent to server 100. While the example herein references information initially input and fed to server 100 via the supply chain, it should be appreciated that information may be fed to server 100 utilizing inventory management information which typically relates to the post-production status of product.

Since information relating to products provided by different merchants is often expected to be formatted differently from one another, product and color data received from merchants must be transformed or normalized so that the information may be handled efficiently and consistently. While the information may be segmented by merchant, a merchant product table or item table 540 is created and maintained to manage, manipulate and search all of the types of information stored in product data storage 206. In practice, as formatted data from the IMS and SCM feeds 510 are introduced to the server 100, they are fed into a middleware engine 520 via an application programming interface. Generally, the middleware engine 520 is segment of software which enables the integration and management of incoming data as the data is transmitted from IMS and SCM systems 500 to server 100. In that regard, the middleware engine 520 manages the interaction between the otherwise incompatible applications residing on the server 100 and merchant IMS and SCM systems 500. While the input of the middleware engine 520 comprises the formatted IMS and SCM feeds 510, the output is normalized or transformed so that the data can be efficiently organized in an item table 540 in accordance with conventional normalization practices that are known in the computer software arts.

In a preferred embodiment, the normalization process 530 also programmatically strips away identification information which could be used to relate product information to a specific merchant when the product information is transmitted outside the server. Accordingly, concern regarding access to sensitive information by competitors is effectively eliminated by removing outside access to the IDs of merchants from the products they sell or which have been sold by that merchant. While the identification information remains available so that a particular merchant can access its own information or create a filter that limits analytical query results to its own data, it is hidden to outside merchants. Thus, associations to an individual merchant persist within the database schema, however, such associations are not directly referenced or available in all database queries. In that regard, while datasets may be queried, a limitation on merchant identification is implemented similar to privacy settings which preclude access to specific forms of information. For example, Merchant A may run an analytical query based on any available combination of demographic variables. This form of query returns results from Merchant A as well as all other merchants with relevant data, without specifically identifying information from the other merchants. Merchant A may also run a query that further includes a merchant filter which limits the preceding query to data specifically associated with the querying merchant, in this case Merchant A. This filter limits information to Merchant A for Merchant A's queries, Merchant B for Merchant B's queries, Merchant C for Merchant C's queries and so on and so forth. Filters corresponding to outside merchants are precluded, but conceivably can be made available if permission is given in advance by a merchant to isolate its information.

It should also be appreciated that while merchant identification is programmatically stripped so that it is unavailable as a filter for conducting certain forms of analytical queries by outside merchants and/or users, merchant identification information can still be identified and/or isolated internally by referencing a unique feed ID which associates a merchant with each product record.

After the normalization process 530 is completed by the middleware engine 520, item table 540 contains all available product information from the proprietary merchant IMS and SCM system 500, which includes a universal color identifier in the form of a hexadecimal color code, preferably along with component RGB values.

There are instances in which merchant IMS and SCM systems 500 and formatted feeds 510 will not contain the appropriate hexadecimal color identification required to classify a product by one of the available, selectable colors. These instances may arise as a result of previously adopted color naming conventions by a merchant or as a result of merchant-vendor practices which are ostensibly incompatible with assigning a universal color code to a given product via the merchant's IMS and SCM system. Under these circumstances, formatted feeds 510 are fitted with an available data field into which an anonymous, preferably digital, color swatch alone or in combination with a merchant color name (or names) for that swatch may be inputted by a merchant.

After the color swatch is formatted and incorporated into the feed 510, it is sent with the rest of the available merchant product data to server 100 where it is transformed or normalized 530 by the middleware engine 520 and then introduced to color engine 550 which performs an analysis of the color swatch 560 to determine its dominant color(s) (and pattern(s) where applicable). As referenced in FIG. 4 and FIG. 5B, primary functions of the image processing module or color engine 550 are to gather and process the available color and pattern data in an image or color swatch presented via the proprietary merchant data feed 510 and to store the color and pattern data as product data 206 560. Thus, the color engine 550 serves as a “reader” of both colors and patterns on behalf of merchants, enabling the system to directly determine the colors and patterns of a product in a given image when that information is not provided via the formatted feed 510. Whether in the form of a color swatch or complicated image of a product, its color and patterns can be “read” by the color engine 550 and introduced to the data storage warehouse 200.

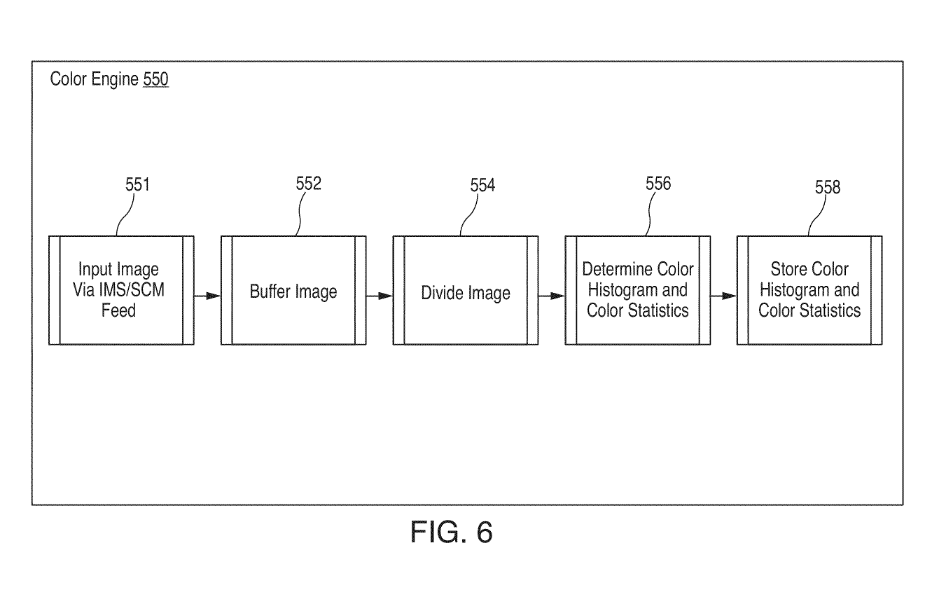

With reference to FIG. 6, the color engine 550 comprises software which analyzes images or swatches 560 in a series of steps which are used to determine the color and/or pattern of a product presented via the formatted data feed 510. The universal color identification information obtained as a result of the analysis is then stored as product data 206. More particularly, the color engine 550 initially receives an anonymous swatch or image 551 as a normalized data input. After receiving the input, the normalized image is then buffered 552 and potentially divided into a plurality of sub-images 554 for purposes of accurately determining component color(s). Thereafter, numerical color values (e.g., RGB and hexadecimal values) associated with those sub-images are determined 556, as well as color histogram and statistical data that may include detailed RGB band information, including the mean, standard deviation and minimum value and maximum value associated with each of the RGB bands.

Once the color data for the swatch are determined 556, the image is associated with a matching color—and most optimally the identical color—that is available in the core color database 570. Where the determined color from the image analysis is not precisely the same as an available color (i.e., one of the 4096 colors) in the core color database 570, the candidate color that is selected is the closest one of the available colors in the core color database 570, as determined by the formula c=sqrt((r−r₁)²+(g−g₁)²+(b−b₁)²), wherein c=closest color; r=first red value; r₁=second red value; g=first green value; g₁=second green value; and b=first blue value b₁=second blue value. Using component RGB values for the candidate colors and known color from the processed image, the closest candidate color to the known color present in the processed product image is the color that yields a value where c is closest to 0. (A value of c=0 means that the colors are the same.)

Once a candidate color is selected as a result of the image analysis 560, a record is created in a color-pattern table 580 which utilizes a unique item or product ID of the product listed in the item table 540 to link a given product provided by a normalized IMS and SCM feed 510 to the candidate color present in the color pattern-table 580 as a hexadecimal code (and component RGB values). This method syncs 590 the normalized IMS and SCM data feeds 510 having converted color fields to the rest of the system, thus establishing a universal color identifier for product that was input into the server 100 without one, and enabling product and its associated color information—input via proprietary IMS and SCM systems 500—to be searched, codified, and dynamically analyzed.

Notably, current and outmoded color conventions and identifications of merchants (the feeds from which do not possess a universal hexadecimal/RGB color code) may be reverse mapped without fundamentally damaging or totally eliminating those merchants' own color naming preferences. Thus, in addition to the system's own color classification, a color, for example, that is identified with RGB code 255 Red: 0 Green: 102 Blue and corresponding hexadecimal code FF0066, may also be identified in the color storage database and/or merchant database using the particular merchant's own unique name or alias, such as “flamingo pink.” Likewise, other merchants that wish to assign their own alias to that very same color may do so using a different name. Regardless of the number of aliases applied to the particular color, the key is that all are codified and searchable using the standardized RGB and/or hexadecimal values assigned to the color.

By reverse mapping all major merchant color systems into one universal color system, a significant hindrance to user searching for and finding products from different merchants is resolved. Reverse mapping enables dynamic analysis and codification of precise color. When layered into proprietary merchant IMS and SCM systems, the search is further enhanced as it is no longer requires scraping the Internet. Likewise, issues associated with merchant product planning and production are ameliorated by providing them with standardized color information on sales, searches and availability.

Following the consumption of normalized data from SCM and IMS feeds 510 and color assignment utilizing universal hexadecimal color identifiers, a number of merchant tools are enabled which pertain to predictive analytics 610, a B2C platform which includes a digital personal shopper application 620, advertising to consumers 630 and other applications 640. Notably, these tools leverage the ability of the system to capture codified color data from a plurality of customized proprietary IMS and SCM systems 500 previously available in the prior art.

By integrating a universal color identification technique into proprietary IMS and SCM systems, available color data can be dynamically analyzed and integrated to enable merchants to make color-based decisions and recommendations on a real-time basis that were heretofore not practical or, at best, based on incomplete information. With respect to supply chain management, inventories of products by particular colors can be managed and prioritized and decisions to replenish inventories can be effected sooner by triggering manufacturing and distribution as soon as, for example, certain sales thresholds are met, inventories dip below a particular level and/or additional consumer need is identified beyond current supply plans and capabilities. Moreover, merchants can also advertise and give information users on expected availability using available supply chain management information. Similarly, such information can be used to allow users to pre-order products. On the inventory side, inventories of available products can be kept more stable by promoting products based on current and near-term availability. Furthermore, where a particular color for a product is unavailable, default settings enable recommendations to be made of the closest matching color. Thus, product search and recommendations can be made considering both current and future inventories.

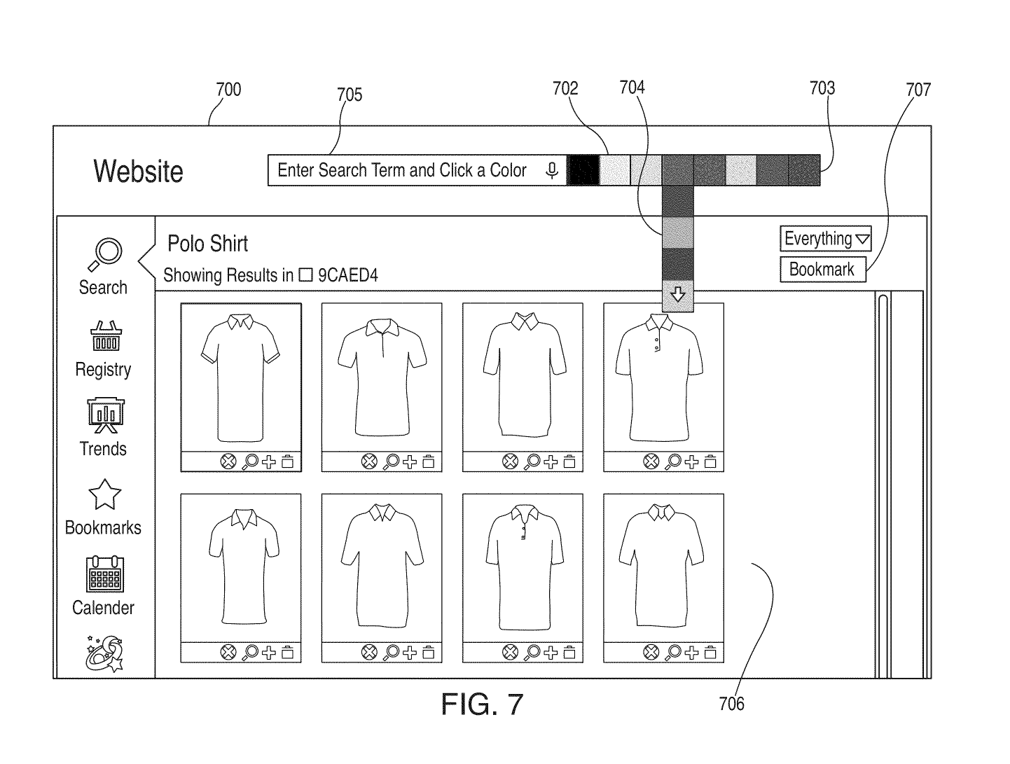

With reference to FIG. 5A and FIG. 7, all user subscribers gain entry and access to a graphical user interface 700 by subscription and by using known security approaches, such as a login and password 710, which are optionally managed by a separate login server (not shown). Once a login 710 is confirmed and a subscriber authenticates, a user's age, gender, location and other demographic information is loaded 720 and the verified user is permitted access to the search query functions 730.

A color-based search query may be initiated via graphical user interface 700. By selecting a selectable color area or swatch 702 along the top of the interface, a user may initiate a search for products from item table 540 (and color pattern table 580) with the associated digital color codes (e.g., in hexadecimal, RGB, binary) that correspond to the selectable color area 702. It should be appreciated that the query/ies sent to item table 540 and to color pattern table 580 may be referred to as a single query for ease of reference since the query received by each table requests essentially the same information. As illustrated in FIG. 7, when a user desires to search for products of a particular color, the user selects a color from one of the selectable color bar colors that appear on the clickable horizontal color bar 703. Once one of the colors on the horizontal bar 703 is selected, a vertical bar 704 expands downward, typically with shades of the initial color selected on the horizontal color bar 703. Once a user makes a final selection a search query is transmitted to the item table 540.

It should be appreciated that queries may also comprise ranged searches such that a user may select two color areas which define boundaries of a color query such that all relevant products that have colors within the predetermined boundary colors are returned as results. By the same token, analytics queries by merchants may be performed in the same manner utilizing two color areas which define boundaries of a color analytics query.

Preferences in the color swatches 702 appearing on the color bars 703, 704 may also be controlled and modified via the user interface 700, typically utilizing the bookmark feature 707. In controlling changes to selectable colors that readily appear on the GUI 700, a user may also be presented with a modify color panel (not shown).

When inputting additional search parameters in the textual search field 705, such as “Polo Shirt,” results coincide with products from item table 540 (and color pattern table 580) that meet both search limitations: 1. “Polo Shirt” and 2. the designated color code, in this case, the hexadecimal color identifier 9CAED4. Search results 740 are returned by the database engine and rendered in a designated display area 706. When resources permit, queries are performed continuously and automatically for products with identifying colors that match those colors that appear as selectable color areas 702 on a user's GUI 700. This enables population of the designated display area 706 with some relevant products from item table 540 before a formal search is initiated by a user.

Ideally, matches that are made comprise products from the item table 540 with associated colors that are identical (e.g., same hexadecimal and RGB values) to the color that is selected on the color bar. However, it may also be desirable under certain circumstances to return products with matching colors which are not identical, but which have a color code identification that is nearly the same or the one closest to the queried color. As noted above, in determining the closest matching color to the queried color, the software executes the following calculation c=sqrt((r−r₁)² +(g−g₁)²+(b−b₁)²), wherein c=closest color; r=first red value; r₁=second red value; g=first green value; g₁=second green value; and b=first blue value b₁=second blue value. The candidate matching color is the one or more colors that yield the value closest to zero.

Furthermore, it should be appreciated that advanced search queries may be performed by a user via the GUI 700, inputting a variety of parameters to narrow search results and, ideally, to find specific types of products that are available for purchase. These parameters may include a second color-based identifier, a specific pattern, or a physical attribute, such as size.

In addition to receiving results 740, a preferred embodiment of the system further provides a user with a number of user actions or options 800 to share the product via a social medium 810 (and to a social database 812), to “like” the product 820, to save the product as a bookmark 830 or into a user registry, to “hide” the product to ensure that it never appears again in a user's search results 840, and to purchase the product 850. When selections are made, they are stored as records in a user history table 860 and conveyed to the real-time analytics segment of the system to analyze and utilize for future recommendations to the user and to others with correlating selections and/or demographics. Thus, information from searches performed by users of available products or merchant inventory is organized and indexed as user data and is used to formulate user preferences that is available to be used for future recommendations to the users providing the data, as well as to other users sharing common user demographics and/or online shopping activities.

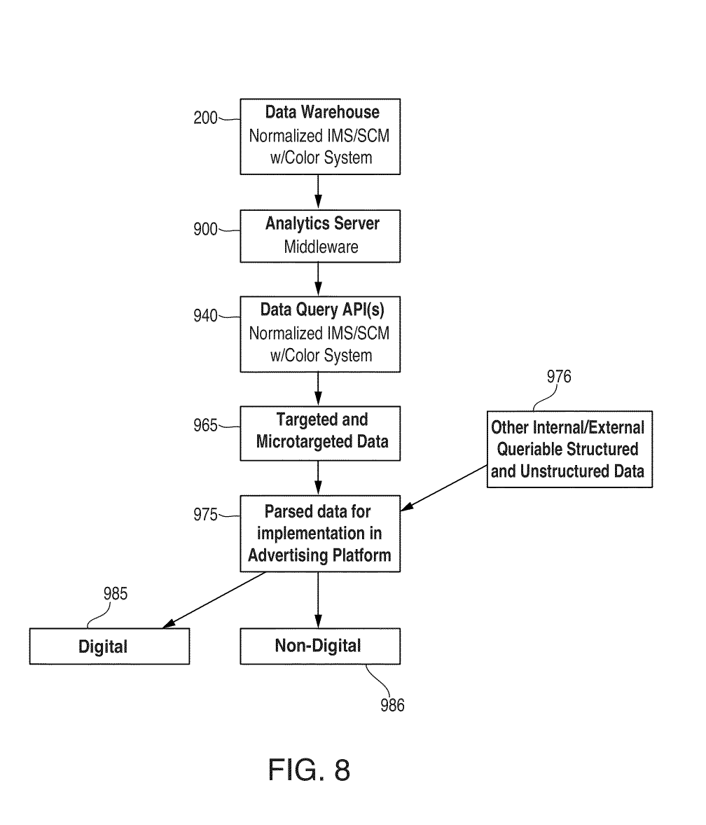

With reference to FIG. 5A, FIG. 5B and FIG. 8, the advertising platform enhancement is preferably utilized in conjunction with the analytics segment of the system. More specifically, the marketing tools provided by the advertising platform to generate and distribute targeted and micro-targeted formatted advertisements and/or customized catalogs 630 to users are put into service by exploiting the information in data warehouse 200 and user history table 860 via analytics server 900. In its broadest sense, the purpose of analytics queries in the advertising context is to locate, compare and match items that a user desires to purchase with items that a merchant has on-hand for sale (or is expecting to have available in the future), as furnished by the SCM and IMS feeds that populate data warehouse 200 and item table 540.

In preferred embodiments, analytics server 900 is implemented as one or more physical or virtualized servers that host middleware for executing queries of data warehouse 200 and/or user history table 860. All user subscribers gain entry and access by subscription and by using known security approaches, such as a login and password 910, which are optionally managed by a separate login server (not shown). Once a user initiates login 910 into the analytics server 900 and is confirmed and authenticated, a user's details are loaded into the analytics user database 920 and the verified user is permitted access to the search query functions 930. Access to query functions 930 is made available via a data query API 940 which comprises a user interface and/or conventional API that has a host of conventional functions for conducting queries and filtering vast amounts of data available in the data warehouse 200 and user history table 860. While certain query functions are standard, the functions made available to individual users via the interface(s) may also be customized to suit a particular user's needs.

In this context, a “user” is likely not a consumer, but a merchant or a third party marketing entity acting on its behalf to create advertisements and/or catalogs to distribute to users. Accordingly, the details which are loaded into the system typically relate to identification information for the merchant on behalf of which advertisements are being generated.

As shown in FIG. 5A and FIG. 5B, the destination of an analytics query passed by the analytics server 900 is dependent upon the type(s) of information requested by that query and where that information is stored. Generally, queries are intended to retrieve information from one or both of item table 540 and user history table 860. In an alternate embodiment, when a merchant (or optionally a marketing entity with authorized access to a merchant's IMS and/or SCM systems) conducts analytic queries 930, direct connectivity to the merchant's IMS and/or SCM systems may optionally be implemented such that a query may retrieve active product status information directly from the merchant's IMS and/or SCM systems (instead of item table 540). It should be appreciated that the range of queries that may be executed is vast and constantly in flux, limited only by the potential combinations of categories of information that are maintained at a given time in the item table 540 and user history table 860. To that end, for example, a single query may be driven by multiple variables, including brand, type of product (e.g., shirt, pants), physical style (e.g., long sleeve, short sleeve), fashion style (e.g., modern, gothic, retro) and material (e.g., cotton, wool).

Other variables which are available are as follows:

1. Keywords—Queries may return or filter out available data based on words contained in the textual fields that are associated with items present in item table 540. These fields typically contain descriptive excerpts about a product.

2. Language—Queries may return or filter out available data based on the language of the words contained in the textual fields that describe products in item table 540.

3. Platform—Queries may return or filter out available data based on whether a product, for example, is currently available and in a retailer's IMS, or whether a product is not currently available, but in production and in the SCM.

4. Location—Queries may return or filter out available data based on where a product is located. Location can be specified, for example, via coordinates (e.g., latitude/longitude), cities, countries or by broader geographic regions, or via a text-based location limitation.

5. Time Zones—Queries may return or filter out available data based on the time zone(s) in which a product or user is located.

6. In Stock—Queries may return or filter out available data based on whether an item is or is not in stock, or based upon the number of units in inventory. This variable may also be tied to color or size limitations where a product can be deemed out of stock if not available in a particular size or color.

7. Color Trends—Queries may return or filter out available data based on colors for particular types of products and/or color preferences for specific demographics (e.g., gender, age group).

8. Gender—Queries may return or filter out available data based on the gender of individuals that purchased product or which have bookmarked certain products in their user history table.

9. Geo-IMS Trends—Queries may return or filter out available data based on the input of multiple “Geo-IMS” variables (and/or variable ranges) to determine world-wide or geographic-specific trends and impact on merchant IMS systems. GEO-IMS variables may include date, time, location, product type, user demographics (e.g., gender, age groups). One example of a GEO-IMS query would be to ask for the most popular cotton shirt brand(s), color(s) and/or size(s) within a 50-mile radius of the 10016 zip code for males, 18-25 years of age.

10. Product Futures—Queries may return or filter out available data based on the anticipated delivery dates of products as noted in SCM and/or IMS systems. Optionally, products set to arrive within a predetermined time frame (e.g., within 30 days) can be flagged as “Coming Soon” or “Item Will Be Available in [X] Week(s). Would You Like to Reserve?”

While the foregoing variables represent a wide range of those which are available for query, it should be understood that other variables are available to return or filter out data in accordance with the other attributes maintained within the item table 540, user history table 860 (or the data warehouse 200 at large). It should further be understood that the variables available herein allow for a more robust analytics query and hence a superior advertising product to other systems that are currently available and which generally limit variables to Keywords, Language, Platform, Location and Time.

With reference to FIG. 5A, FIG. 5B and FIG. 8, once a query 930 from the analytics server 900 is performed, the search results 960 are returned. The query results 960 are utilized to generate analytics reports 970 displayed on a user interface with graphical and/or textual information. Generally, analytics reports 970 break down the search results 960 in accordance with the variables utilized to formulate the query. As incorporated into the advertising platform, the results 960 may be further classified as targeted and/or micro-targeted data 965 and comprise much of the substantive or product content of the formatted advertisements and catalogs that are generated and distributed. After isolating the targeted and micro-targeted data 965, the parsed data is passed or made available 975 to the advertising platform 980 and/or other B2B and B2C applications.

In an alternate implementation of the present invention, other internal or external queriable structured or unstructured data 976 may be introduced into the advertising platform 980 along with the targeted and micro-targeted data 965 enabling more effective advertising to users. Data 976 may include data on weather, news, sporting events, financial news, media, social media and the like. As this data 976 is introduced, parsed into a meaningful form and incorporated into the system, more effective advertisements are generated to users. For example, if the weather forecast shows rain for the next few days, advertisements may be generated that suggest and provide coupons for rain gear and related rain products. If a local team advances in the playoffs, advertisements may be generated that promote and offer discounts off the team's jerseys or t-shirts.

Another example where data 976 may be incorporated into the advertising platform 980 to generate advertisements involves the extraction of product data relating to products appearing in media, such as movies or TV shows. In particular, if an actor starring in a movie wears a particular color or fashion style of clothing or accessories from a particular designer, the appearance of the clothing and accessories in the movie may be employed as a factor which bolsters advertisements to users of such products. The decision to generate and distribute such advertisements may be further bolstered by social media factors including whether critics have commented positively about the products appearing in the movie and/or whether persons appearing in social media photographs or videos are wearing the same clothing or clothing of similar style. The same principles may be applied to home goods, furniture and a host of products appearing in media and social media.

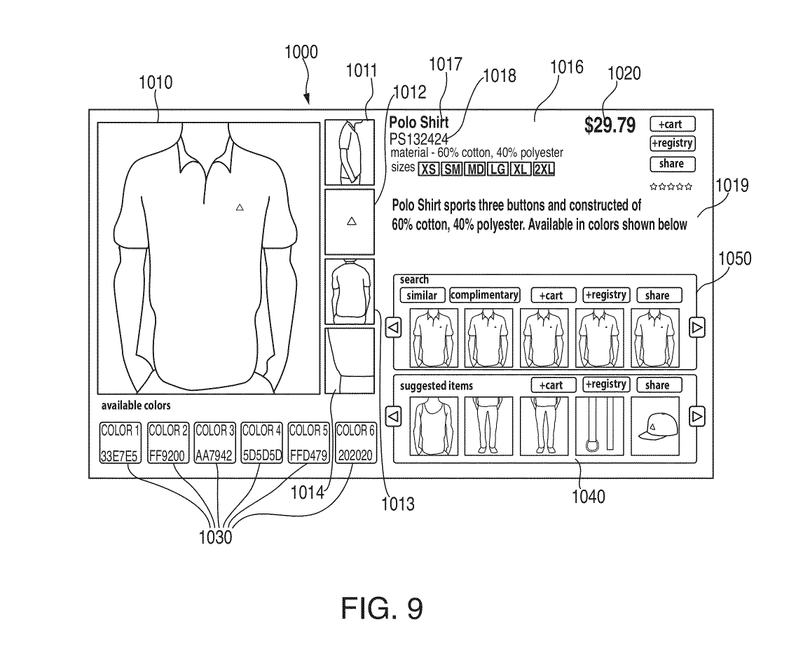

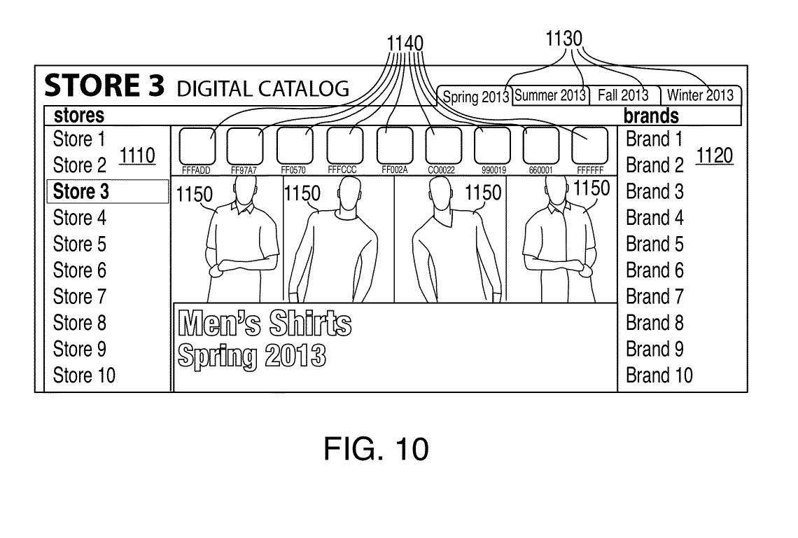

As part of its role in generating digital content 985 and non-digital content 986, advertising platform 980 serves at least two basic functions. First, the advertising platform generates formatted digital advertisements, such as the one shown in FIG. 9, and promotional materials (e.g., coupons) which are delivered, for example, via traditional email or messaging, during an in-store shopping excursion, or during an online browsing session. Second, the advertising platform generates formatted, customized catalog advertisements in the form of digital catalogs, a layout interface of which is shown in FIG. 10, that can be made available for browsing via a mobile or desktop interface 1100 or delivered virtually via email or messaging or delivered via mail in the form of a physical catalog.

Whether in the context of generating an advertisement, a catalog or other marketing materials via the advertising platform 980, it should be appreciated that any may contain content that is targeted and/or micro-targeted, depending on the nature of information that is available about a user in the user history table 860. Targeted marketing materials are produced when there is limited data available about the user in the user history table 860, such as data limited to age, gender, location or other basic demographic identifier which is provided by a user, for example, during initial sign-up. When the advertising platform 980 possesses relatively limited information about a user, the advertisements, catalogs and other marketing materials that are generated for a particular user (or group of users for which the same limited information is available) are based, for example, on what others of the same gender, age group and location prefer and have purchased.

In contrast, as a particular user interacts with the item table 540 by conducting queries 730 and populating the user history table 860 through sharing 810, liking 820, bookmarking 830, hiding 840, purchasing 850 and other historical interactions, more results 960 are returned in response to an analytics query 930. In turn, more data is available to the advertising platform 980 and the marketing materials that are created can be further customized or “micro-targeted” to that user's actual preferences alone or in conjunction with the demographics information previously made available. The foregoing activities 810, 820, 830, 840, 850, whether alone or coupled with the activities of other users in a user's affinity or social group, generate vast amounts of data which are collected and used to further enhance available predictive analytics and the advertisements and marketing materials that are generated. As time passes and data is collected, patterns form with respect to, for example, style (e.g., modern, retro, classic, and contemporary), product interests (e.g., clothing versus home goods versus cars), materials (e.g., natural fibers, blends, wool) and sizing (e.g., small, medium, large, XL). Utilizing the available information enables advertisements to contain appropriate product content and to direct that content to users who are most likely to purchase those products.

Notably, it should be understood that users may receive both targeted advertising as well as micro-targeted advertising contemporaneously (or within very short time frames). Depending on the types of products that merchants wish to advertise, a user may receive micro-targeted advertising on one type of product for which there is a plethora of information about the user's preferences (e.g., pants) and only targeted advertising on which the user has not indicated any preferences (e.g., home goods).

One example of an advertisement 1000 created by the advertisement platform is shown in FIG. 9, which is presented as a desktop PC advertisement. In a preferred embodiment, each formatted advertisement presents an organized layout with identification information that includes one or more digital renditions, 3D models or photographs 1010, 1011, 1012, 1013, 1014 of the featured product in one or more perspectives; product type 1016; brand 1017; product ID code 1018; textual description 1019; price 1020; and available colors which is presented as clickable color swatches 1030 that are each encoded with a universal color identifier. In this case, the product is available in the six colors encoded and identified by universal hexadecimal color identifiers 33E7E5, FF9200, AA7942, 5D5D5D, FFD479 and 202020. Other information, including material and sizes are available as well. It should be understood that the layout of an advertisement may be customized by a merchant sourcing the advertisement depending on that merchant's requirements and preferences and the products being advertised.

In a preferred embodiment, formatted advertisement 1000 also provides means to enable upselling and/or cross-selling of additional product besides the featured product in the advertisement 1000. In particular, advertisement 1000 includes dedicated areas for suggested items 1040 and/or automatic search items that are similar or complimentary 1050 to the featured item. In both instances 1040, 1050 advertisements reflect availability, as discussed in more detail below.

With respect to mobile formatted advertising, the advantage of being integrated with merchant SCM and IMS systems further encourages the generation and transmission of in-store advertising to users of products in which a user is or may be interested. For example, when shopping in a particular store, formatted mobile, micro-targeted advertisements and other marketing materials, such as coupons, that are specific to that store are instantly created and sent to a user to take advantage of the user's presence in the store. Likewise, when passing within a predetermined distance of a physical store (e.g., 15-100 feet), advertisements and coupons are be generated and distributed to drive traffic into a store.

Generation and distribution of mobile advertisements to a user are enabled upon authentication of the mobile device and permission given by the user to receive mobile advertisements prior or subsequent to authentication. General permissions may be given to receive advertisements from all merchants, or specific permissions may be given to receive advertisements from only specific merchants. Moreover, a user may set up distances within which a mobile advertisement may be sent, ranging from advertisements being sent exclusively in-store or as far as some predetermined distance from the store (e.g., within 15-100 feet). Regardless of range, associations may be determined and enabled by the mobile device using its geolocator capabilities. Preferably, initiation of the mobile device association with a particular merchant or physical location is premised on the availability of product in that store in which a user would be interested in purchasing.

As taught in U.S. application Ser. No. 13/762,281 and corresponding international application PCT/U.S.13/25200, once in the store, a device's precise location within the store can be identified and mapped to the store planogram and/or schematic using known geolocator techniques. In combination with available schematic and planogram information, user demographics and/or preferences as recorded in user history table 860 are employed to generate and transmit even more effective targeted and micro-targeted advertisements. In particular, both targeted and micro-targeted advertisements and coupons are transmitted to a user's mobile device at well-timed, opportune moments as a user strolls in the vicinity of products for which that user is searching or is otherwise most likely to pick up for purchase.

Using the same guidelines, advertisements that encourage the purchase of products for another in a user's affinity or social group may likewise be generated and transmitted in the same manner. In particular, if a first user is shopping for a second user in the first user's affinity or social group, marketing materials may be transmitted to the first user based on the second user's shared preferences. Thus, both targeted and micro-targeted advertisements and coupons may be sent to the first user's mobile device at well-timed, opportune moments as a user strolls in the vicinity of products which are intended to be marketed for purchase by or on behalf of the second user.

In conjunction with formatted advertisements or as a separate form of digital marketing, a preferred embodiment of the present invention incorporates a basic messaging capability which provides marketing notices to users regarding products, including, for example, 1. new products which have become available; 2. products which were temporarily unavailable; 3. products which are expected to become available in the near future or previews of products; 4. products which are discounted; 5. products with low inventory. Like formatted advertisements, notifications are generated and transmitted utilizing user demographics and/or user preferences based on user history table 860 to create targeted and micro-targeted notifications. Such notifications are typically sent to handheld devices, preferably with accompanying graphic representations of the product (but may even be transmitted without, using SMS).

A second function of the advertising platform 980 is the creation or generation of digital catalogs and print catalogs, both of which are tailored to individual users in accordance with their demographics (targeted) and/or user preferences and interactions (micro-targeted) as recorded in user history table 860. In a preferred embodiment, each catalog that is generated preferably comprises or gives access to a number of formatted advertisements commissioned by merchants and based upon analytic query results sent to the advertising platform. More particularly, digital catalogs generated by or on behalf of a particular merchant for a particular user (or group of users) based on the user's (or users') demographic information or preference information contain a subset of products from the item table 540. Aside from the analytics queries which filter and return product results from the item table 540 and/or user table 860 for display in a digital catalog, the products generated and displayed in the desktop- or mobile-based digital catalog interface can be filtered further by users, depending on the interactive selections, such as color selections, that can be made by users when viewing the catalog, as discussed below.

With reference to FIG. 10, a desktop- or mobile-based digital catalog interface 1100 is provided. Along the left side of the interface 1100 is a store menu 1110 comprising a number of selectable merchants or stores on behalf of which a digital catalog is created for one or more users. Along the right side of the interface 1100 is a brand menu 1120 comprising a number of selectable brands of products sold at stores. Once a store or brand is selected, a dropdown box or sub-menu of product categories is provided for selection within that store or brand. It should be appreciated that in a number of instances there may be overlap between the store menu 1110 and brand menu 1120 for brands that operate as stores. Along the top of the interface 1100 is a set of season tabs 1130 comprising selectable seasons for which catalogs are available for a particular store and/or brand. Beneath the season tabs 1130 are a number of color swatches 1140 that are each encoded with a universal color identifier. Beneath, the swatches 1140 are a number of digital renditions, 3D models, videos or photographs of featured products 1150, optionally products in a particular product category, in this case Men's Shirts 2013.

It should be appreciated that the contents of the catalog interface 1100 are populated by the normalized merchant IMS and SCM feeds through item table 540 so that products which are not in stock, not available in a particular preferred color and/or not available in a particular size are not incorporated in catalogs to users having preferences for products that are not available. Moreover, other features or menus may be provided in the interface 1100, including menus of product categories or departments, or menus exhibiting multiple users for when a user is shopping for others in that user's social group.

By making a selection from the store menu 1110, a user can view digital catalogs from a particular store, by season. Likewise, by making a selection from the brand menu 1120, a user can view digital catalogs of products corresponding to a particular brand, regardless of the stores in which they may be sold. In a preferred embodiment, a selection of a store from the store menu 1110 may be supplemented by a selection of a brand from the brand menu 1120 (and vice versa), which in many instances will result in a viewable catalog that corresponds to particular brands of products sold in a particular store. Generally, once a store or brand is selected, products are displayed for viewing in the form of selectable advertisements. Once selected, the selectable advertisements from the catalog may be highlighted or enlarged to appear as formatted advertisements, such as that appearing in FIG. 9. If no color swatches have been pre-selected, the formatted advertisements display the different colors in which the selected product is available.

In addition to the selection of a particular store and/or brand, a user may also search for products from catalogs which are available in particular colors by selecting from any one or more of the color swatches 1050. Depending on the availability of products in selected colors, the contents of the catalog interface 1100 may be filtered or changed dynamically to display only those products for which there are products corresponding to the selected colors. The selectable color swatches that are displayed may be changed manually by a user or limited to the range of colors of products appearing in the digital catalog. Since the catalog is typically customized to a user's preferences with micro-targeted advertisements, the presence of selectable color swatches is typically indicative of colors towards which the user already harbors an affinity. Where the catalog comprises targeted advertisements based on user demographics but without sufficient user input or preference information in the user table 860, the presence of selectable color swatches are more prone to be changed manually by a user.

By virtue of the store and brand menus that are provided, the desktop-and mobile-based interface 1100 serves as an amalgamation of merchant catalogs which are available simultaneously for viewing. While the interface 1100 is designed to display multiple catalogs of different merchants or brands at the same time, it should be understood that any merchant store or merchant brand may separate its own products into a single customized user catalog and transmit the catalog electronically or distribute it physically and “push” it out at will to users for marketing purposes to spark user interest.

Since many merchant retailers utilize catalogs to generate revenue from suppliers which pay to advertise their products in the catalog, the ability for a retailer to create customized digital catalogs that are individually tailored to users offers the potential to substantially reduce the expense for both merchant retailers and their merchant suppliers of creating physical catalogs while still securing revenues and other benefits that accrue from catalog advertising. Moreover, even in the context of physical catalog generation which typically comes at great expense, the ability to customize the catalogs to present products that users are more likely to purchase based on what is known about their demographics, interactions and preferences, offers a greater value in that a user will be more likely to purchase an item presented in the catalog. In both instances, the ability to tailor catalogs and send them out much more frequently—whether alone or in conjunction with dynamic changes in user history—offers immense opportunity to merchants in that a much larger percentage of the products that appear in the catalog are likely to be purchased. This is in stark contrast to current catalogs that feature such a large range of products that it is virtually impossible for all those products to appeal to the individual receiving the catalog.

In a preferred embodiment of the present invention, an unlimited number of digital catalogs may be dynamically generated for users by merchants based on individual user preferences, demographics, and available (or soon to be available) merchant products. Once one or more digital catalogs are generated, they are saved and at least the most recent version is available for access and/or pushed out for distribution to known email (or other digitally accessed) addresses or directly to a handheld device. By way of example, when a user accesses Merchant 1's catalog in June 2013, the products displayed in Merchant 1's catalog correspond to a combination of that user's preferences, history, demographics, and Merchant 1's products which are available or will be available in the near future. As the combination of the user's preferences and demographics and the user's history and availability change over time, Merchant 1's catalog for that particular user changes to provide the user with more appropriate and effective advertising for that particular time. Thus, subsequent accesses by a user, even within the same season may result in a merchant digital catalog which shows different product selection. When changes to a customized merchant catalog are made for a user, the updated catalogs may be transmitted electronically (e.g., via email or via messaging) instantly to reflect current status.

Whether an advertisement or catalog with a particular advertisement is generated and transmitted to a user depends, in part, on availability factors, such as whether a product is in stock, whether a product is available in the user's size, and whether the product is available in at least one of the user's preferred colors. Accordingly, when a product is not in stock (and not expected to be in stock in the foreseeable future) or not available in that user's size or in a preferred color, an advertisement for that product will not be generated and transmitted to that user. In contrast, if the product is available but not in all sizes, for example, an advertisement may be generated for some users but not those for which the product will not fit. Thus, in all forms of marketing materials generated by the advertising platform 980, the connectivity to merchant SCM and IMS systems ensures that delivered advertisements and advertising space is not unintentionally wasted on products that are not in stock, or at least in pre-production process.

In addition to ensuring that a particular type of product is not advertised when that type of product is not in stock, the advertising platform further ensures, that specific product recommendations are not made when there is available stock of a particular product type, but no available stock of the product type in a particular configuration. For example, if a product is not available in a user's size, even though it is available in other sizes, the product will not appear in an advertisement or ‘purchase suggestion’ to that particular user.

Using the same guidelines, if a first user is shopping for a second user in the first user's affinity or social group, product suggestions or advertisements will not be made to the first user based on the second user's shared preferences if there is stock of the product, but not in the size that is desired by the second user. The same type of ‘rule’ may be created vis-à-vis the second user's color preferences, material preferences (e.g., cotton, wool), distance limitations (e.g., more than 10 miles away) etc. Positive impacts of this feature for merchants and consumers shopping for members in their affinity or social group are the reduction of returns and restocking costs, reduction in time spent on returns, and eliminating the difficulties associated with gift returns that are sent to others who live out of town with no cost-effective means to return a gift to a store that is not local.

Regardless of the type of advertisements or catalogs being distributed, an optional approval command or feature may be provided to merchants prior to the distribution of advertisements or catalogs. Where advertisements or catalogs are intended to be transmitted to a group of users simultaneously across a number of different user demographics, product categories and/or product attributes, approval commands may be customized to limit the transmission of advertisements or catalogs to one or more subsets thereof, as desired.

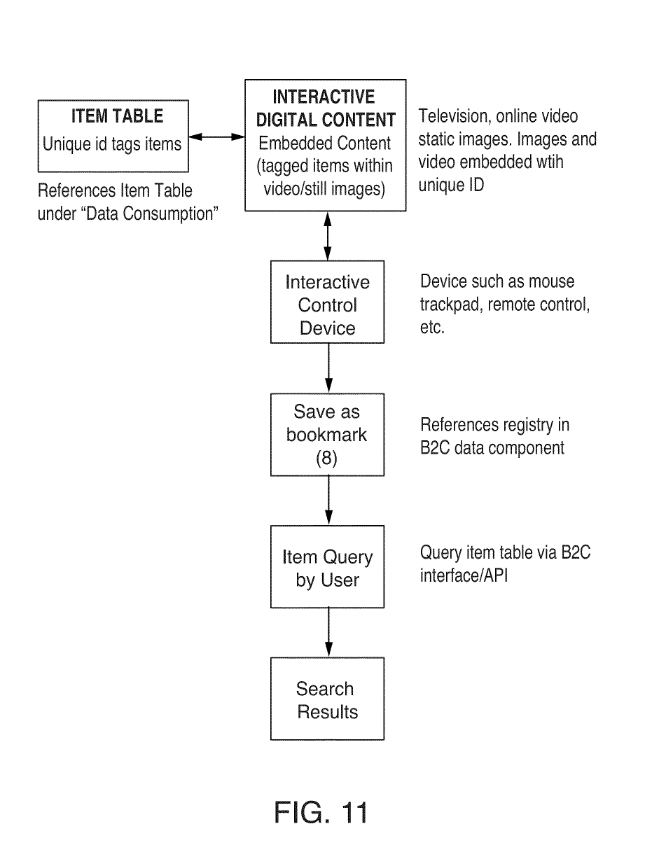

With reference to FIG. 11, a form of interactive embedded advertising is provided which builds upon the infrastructure implemented in connection with the core system. Digital images or video content streams comprising, for example, TV shows and movies, are embedded with unique product IDs corresponding to items in item table 540. This process is typically carried out in pre-production of the content prior to presentation to the user. The unique product IDs correspond to product displayed to a user in the images or video. After the process of embedding, a user may select the product by, for example, clicking on the screen with a mouse or touching with a finger as the content is being played, which will save the product as a bookmark 830 in the user history table 860. Availability information pertaining to this product once it reaches the user history table 860 is updated via the item table 540 and the formatted IMS and SCM information fed thereto. Once saved in the history table 860, a user can refer to the product in the user's registry and purchase when desired if the product is available. If time passes without a purchase, advertisements may further be sent by the advertising platform 980 that correspond to the product. Likewise, selecting the product once it is saved yields similar or complementary products in which a user may be interested. Time limitations or expiration dates may also be embedded into the content for efficiency and to ensure that product content is generally current and/or reflective of current styles and trends.

The accompanying description and drawings only illustrate several embodiments of the advertising platform enhancement of the present invention, however, other forms and embodiments are possible. Accordingly, the description and drawings are not intended to be limiting in that regard. Thus, although the description above and accompanying drawings contain much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments may be practiced by those of ordinary skill in the art without departing from the spirit and scope of the invention.

1. With a processor controlled system in communication with a non-transitory computer readable storage medium in communication with merchant IMS/SCM feeds, a method of generating formatted, graphical advertisements comprising the steps of:
providing an item table, said item table having identification attributes associated with each of a plurality of products which are populated in said item table via said merchant IMS/SCM feeds;
providing a user history table containing records of users that correspond to said users' actions with respect to products populated in said item table;
performing a query of said user history table and returning analytic results in response to said query; and
generating a formatted, graphical advertisement of an advertised product based upon said analytics results.

2. The method of claim 1 wherein one of said identification attributes is a universally identifiable color value.

3. The method of claim 2 wherein said advertised product appearing in said formatted, graphical advertisement has a color that corresponds to said universally identifiable color value.

4. The method of claim 1 wherein one of said identification attributes is one of a plurality of digital color codes being formed from a concatenation of digital values for R, G and B components of a color.

5. The method of claim 4 wherein said advertised product appearing in said formatted, graphical advertisement has a color that corresponds to said one of a plurality of digital color codes.

6. The method of claim 1 wherein one of said identification attributes is one of a plurality of color swatches having a color that corresponds to a hexadecimal color code.

7. The method of claim 6 wherein said advertised product appearing in said formatted, graphical advertisement has a color that corresponds to said color of said color swatch.

8. The method of claim 1 wherein said identification attributes comprise a plurality of availability factors, and wherein said formatted, graphical advertisement of said advertised product is generated only when said availability factors demonstrate that said advertised product is available for sale.

9. The method of claim 8 wherein said availability factors comprise a preferred color attribute.

10. The method of claim 8 wherein said availability factors comprise a size attribute.

11. The method of claim 8 wherein said availability factors comprise an in-stock attribute.

12. The method of claim 1 further comprising the step of providing an approval command option that limits the transmission of said formatted, graphical advertisement.

13. The method of claim 1 further comprising the step of transmitting said formatted, graphical advertisement to users.

14. The method of claim 1 wherein said formatted, graphical advertisement comprises targeted content based upon demographics data in said user history table.

15. The method of claim 1 wherein said formatted, graphical advertisement comprises micro-targeted content based upon historical interaction data in said user history table.

16. The method of claim 1 wherein said formatted, graphical advertisement comprises micro-targeted content based upon demographics data in combination with historical interaction data in said user history table.

17. A processor-controlled non-transitory computer readable storage medium, in communication with merchant IMS/SCM feeds, said non-transitory computer readable storage medium storing one or more programs, the one or more programs comprising instructions, which when executed by a computer, cause the computer to:
provide an item table, said item table having identification attributes associated with each of a plurality of products which are populated in said item table via said merchant IMS/SCM feeds;
provide a user history table containing records of users that correspond to said users' actions with respect to products populated in said item table;
perform a query of said user history table and return analytic results in response to said query; and
generate a formatted, graphical advertisement of an advertised product based upon said analytics results.

18. The device of claim 17 wherein one of said identification attributes is a universally identifiable color value.

19. The device of claim 18 wherein said advertised product appearing in said formatted, graphical advertisement has a color that corresponds to said universally identifiable color value.

20. The device of claim 17 wherein one of said identification attributes is one of a plurality of digital color codes being formed from a concatenation of digital values for R, G and B components of a color.

21. The device of claim 20 wherein said advertised product appearing in said formatted, graphical advertisement has a color that corresponds to said one of a plurality of digital color codes.

22. The device of claim 17 wherein one of said identification attributes is one of a plurality of color swatches having a color that corresponds to a hexadecimal color code.

23. The device of claim 22 wherein said advertised product appearing in said formatted, graphical advertisement has a color that corresponds to said color of said color swatch.

24. The device of claim 17 wherein said identification attributes comprise a plurality of availability factors, and wherein said formatted, graphical advertisement of said advertised product is generated only when said availability factors demonstrate that said advertised product is available for sale.

25. The device of claim 24 wherein said availability factors comprise a preferred color attribute.

26. The device of claim 24 wherein said availability factors comprise a size attribute.

27. The device of claim 24 wherein said availability factors comprise an in-stock attribute.

28. The device of claim 17 the one or more programs further including instructions to provide an approval command option that limits the transmission of said formatted, graphical advertisement.

29. The device of claim 17 the one or more programs further including instructions to transmit said formatted, graphical advertisement to users.

30. The device of claim 17 wherein said formatted, graphical advertisement comprises targeted content based upon demographics data in said user history table.

31. The device of claim 17 wherein said formatted, graphical advertisement comprises micro-targeted content based upon historical interaction data in said user history table.

32. The device of claim 17 wherein said formatted, graphical advertisement comprises micro-targeted content based upon demographics data in combination with historical interaction data in said user history table.

33. With a processor controlled system in communication with a non-transitory computer readable storage medium in communication with merchant IMS/SCM feeds, a method of generating formatted, graphical advertisements comprising the steps of:
providing an item table, said item table having identification attributes, including a universal color identifier, associated with each of a plurality of products which are populated in said item table via said merchant IMS/SCM feeds;
providing a user history table containing records of users that correspond to said users' actions with respect to products populated in said item table;
performing a query of said user history table and returning analytic results in response to said query, said analytic results including said universal color identifier; and
generating a formatted, graphical advertisement of an advertised product based upon said analytics results.

34. The method of claim 33 wherein said advertised product appearing in said formatted, graphical advertisement has a color that corresponds to said universal color identifier.

35. The method of claim 34 wherein said universal color identifier is formed from a concatenation of digital values for R, G and B components of a color.

36. The method of claim 34 wherein said universal color identifier is one of a plurality of color swatches having a color that corresponds to a hexadecimal color code.

37. The method of claim 33 wherein said identification attributes further comprise a plurality of availability factors, and wherein said formatted, graphical advertisement of said advertised product is generated only when said availability factors demonstrate that said advertised product is available for sale.

38. The method of claim 37 wherein said availability factors comprise a preferred color attribute.

39. The method of claim 37 wherein said availability factors comprise a size attribute.

40. The method of claim 37 wherein said availability factors comprise an in-stock attribute.

41. The method of claim 33 further comprising the step of providing an approval command option that limits the transmission of said formatted, graphical advertisement.

42. The method of claim 33 further comprising the step of transmitting said formatted, graphical advertisement to users.

43. The method of claim 33 wherein said formatted, graphical advertisement comprises targeted content based upon demographics data in said user history table.

44. The method of claim 33 wherein said formatted, graphical advertisement comprises micro-targeted content based upon historical interaction data in said user history table.

45. The method of claim 33 wherein said formatted, graphical advertisement comprises micro-targeted content based upon demographics data in combination with historical interaction data in said user history table.

46. A processor-controlled non-transitory computer readable storage medium, in communication with merchant IMS/SCM feeds, said non-transitory computer readable storage medium storing one or more programs, the one or more programs comprising instructions, which when executed by a computer, cause the computer to:
provide an item table, said item table having identification attributes, including a universal color identifier, associated with each of a plurality of products which are populated in said item table via said merchant IMS/SCM feeds;
provide a user history table containing records of users that correspond to said users' actions with respect to products populated in said item table;
perform a query of said user history table and returning analytic results in response to said query, said analytic results including said universal color identifier; and
generate a formatted, graphical advertisement of an advertised product based upon said analytics results.

47. The device of claim 46 wherein said advertised product appearing in said formatted, graphical advertisement has a color that corresponds to said universal color identifier.

48. The device of claim 47 wherein said universal color identifier is formed from a concatenation of digital values for R, G and B components of a color.

49. The device of claim 47 wherein said universal color identifier is one of a plurality of color swatches having a color that corresponds to a hexadecimal color code.

50. The device of claim 46 wherein said identification attributes further comprise a plurality of availability factors, and wherein said formatted, graphical advertisement of said advertised product is generated only when said availability factors demonstrate that said advertised product is available for sale.

51. The device of claim 50 wherein said availability factors comprise a preferred color attribute.

52. The device of claim 50 wherein said availability factors comprise a size attribute.

53. The device of claim 50 wherein said availability factors comprise an in-stock attribute.

54. The device of claim 46 the one or more programs further including instructions to provide an approval command option that limits the transmission of said formatted, graphical advertisement.

55. The device of claim 46 the one or more programs further including instructions to transmit said formatted, graphical advertisement to users.

56. The device of claim 46 wherein said formatted, graphical advertisement comprises targeted content based upon demographics data in said user history table.

57. The device of claim 46 wherein said formatted, graphical advertisement comprises micro-targeted content based upon historical interaction data in said user history table.

58. The method of claim 46 wherein said formatted, graphical advertisement comprises micro-targeted content based upon demographics data in combination with historical interaction data in said user history table.
